(19) United States
(12) Patent Application Publication
(10) Pub. No.: US 2010/0106771 A1
(43) Pub. Date: Apr. 29, 2010

(54) METHOD AND APPARATUS FOR COMMUNICATION BASED ON CERTIFICATION USING STATIC AND DYNAMIC IDENTIFIER

(75) Inventors: Hee-jae PARK, Hwaseong-si (KR); Jun-bum SHIN, Suwon-si (KR); Ji-soon PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/472,417

(22) Filed: May 27, 2009

(30) Foreign Application Priority Data
Oct. 24, 2008 (KR) 10-2008-0104790

(51) Int. Cl. G06F 15/16

(52) U.S. Cl. 709/203

(57) ABSTRACT

Provided are a method and an apparatus for communication based on certification using a static identifier and an updatable dynamic identifier allowing a verified client to access a server.

### CROSS-REFERENCE TO RELATED PATENT APPLICATION

This application claims the benefit of Korean Patent Application No. 10-2008-0104790, filed on Oct. 24, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate communication between a client and a server, and more particularly, to a method and apparatus for communication based on certification.

2. Description of the Related Art

As wired/wireless communication technologies have rapidly developed, contents have been increasingly transferred via wired/wireless networks. Since information is transferred between two remote devices via a wired/wireless network, security may be compromised. It is always possible that devices, which are not authorized to transmit or receive contents, may obtain security information and use it in an unauthorized manner (e.g., for hacking or wiretapping). In particular, if an unscrupulous user manufactures unauthorized copies of a genuine device, a server transmitting contents sometimes cannot distinguish whether a client receiving contents is a genuine device or an unauthorized copy.

Conventionally, a unique identifier of a client is used to verify the authenticity of the client. A server determines if a client is genuine by using a serial number assigned to the client when the client is manufactured or initially operated. Since it is difficult to find out or change the unique identifier of the client, the authenticity of a product has been typically verified using the unique identifier. However, as counterfeiting becomes more sophisticated, the unique identifier is also copied. Thus, certification cannot be efficiently performed only using a unique identifier.

### SUMMARY OF THE INVENTION

Exemplary embodiments of the present invention provide a method and an apparatus for communication, and more particularly, a method and an apparatus for communication between a client and a server based on certification. The exemplary embodiments of the present invention also provide a computer-readable recording medium having recorded thereon a program for operating the method.

According to an aspect of the present invention, there is provided a method of communication of a client with a first server, the method including: transmitting a static identifier and a first dynamic identifier to a second server; receiving from the second server a second dynamic identifier created by the second server by updating the first dynamic identifier; and accessing the first server based on the second dynamic identifier, wherein the first dynamic identifier is a dynamic identifier previously received from the second server when the client previously communicates with the first server.

The second server may update the first dynamic identifier to create the second dynamic identifier whenever the client communicates with the first server.

The first dynamic identifier and the second dynamic identifier may be random numbers.

The first dynamic identifier may be identical to the static identifier when the client initially accesses the first server.

According to another aspect of the present invention, there is provided a method of communication of a first server with a client, the method including: receiving from a second server a static identifier and a second dynamic identifier, created by updating a first dynamic identifier, of the client; and allowing the client access based on the second dynamic identifier, wherein the second server receives from the client the static identifier and the first dynamic identifier, determines whether a previous dynamic identifier corresponding to the static identifier is identical to the first dynamic identifier, updates the first dynamic identifier based on a result of the determination to create a second dynamic identifier, and transmits the second dynamic identifier to the client.

According to another aspect of the present invention, there is provided a client apparatus communicating with a first server including: a certification interface which transmits a static identifier and a first dynamic identifier to a second server, and receives from a second server a second dynamic identifier created by a second server by updating the first dynamic identifier; and a communication interface accessing the first server based on the second dynamic identifier, wherein the first dynamic identifier is a dynamic identifier previously received from the second server when the client previously communicates with the first server.

According to another aspect of the present invention, there is provided a first server apparatus communicating with a client including: a certification interface receiving from a second server a static identifier and a second dynamic identifier created by the second server by updating a first dynamic identifier; and a communication interface allowing the client's access based on the second dynamic identifier, wherein the second server receives from the client the static identifier and the first dynamic identifier, determines whether a previous dynamic identifier corresponding to the static identifier is identical to the first dynamic identifier, updates the first dynamic identifier based on a result of the determination to create a second dynamic identifier, and transmits the second dynamic identifier to the client.

According to another aspect of the present invention, there is provided a computer-readable recording medium having recorded thereon a program for operating the client and the method of communication of a first server.

### BRIEF DESCRIPTION OF THE DRAWINGS

The above and other features and aspects of the present invention will become more apparent by describing in detail exemplary embodiments thereof with reference to the attached drawings in which:

FIG. 1 is a flow chart illustrating a communication method according to an embodiment of the present invention;

FIGS. 2A to 2C illustrate a plurality of identifiers according to an embodiment of the present invention;

FIG. 3 is a flowchart illustrating a communication method according to another embodiment of the present invention;

FIG. 4 illustrates a client according to an embodiment of the present invention;

FIG. 5 illustrates a first server according to an embodiment of the present invention; and

FIG. 6 illustrates a second server according to an embodiment of the present invention.

### DETAILED DESCRIPTION OF THE INVENTION

Exemplary embodiments of the present invention will now be described in detail with reference to the attached drawings.

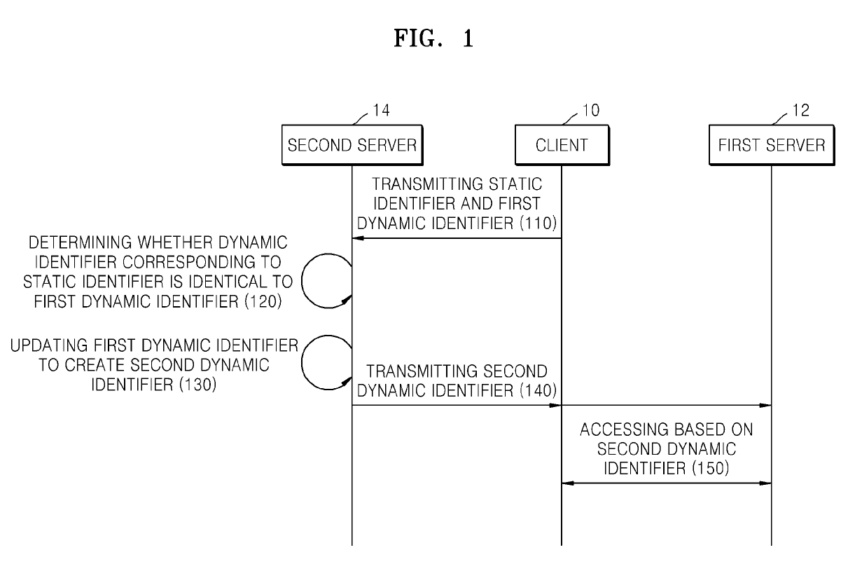

FIG. 1 is a flow chart illustrating a communication method according to an embodiment of the present invention.

Referring to FIG. 1, a client 10 may be a terminal using contents such as a TV, a set top box, a cellular phone, or the like. A first server 12 may be a server providing the terminal with contents. A second server 14 is a certification server performing certification of the client 10. The first server 12 and the second server 14 may be physically separated or logically separated according to their functions within a single server.

In operation 110, the client 10 transmits a static identifier and a first dynamic identifier to the second server 14. If certification is performed only using a unique identifier, i.e., a static identifier, as in conventional certification, an unauthorized copy of the device including a copy of the unique identifier may also be verified, and thus the first server 12 may provide contents to the unauthorized copy of the device which should not have rights to receive contents. For example, if the first server 12 provides updated firmware to clients as a post-sale customer service, the post-sale customer service may be provided to the unauthorized copy of the device.

According to an exemplary embodiment of the present invention, certification is performed using a static identifier and a dynamic identifier corresponding to the static identifier in order to prevent unauthorized use of contents which may occur when only a static identifier is used for the certification. The unauthorized copy may be accurately detected by using not only the static identifier but also the dynamic identifier in the certification. For this, in operation 110, the client 10 transmits not only the static identifier but also the first dynamic identifier to the second server 14, a certification server.

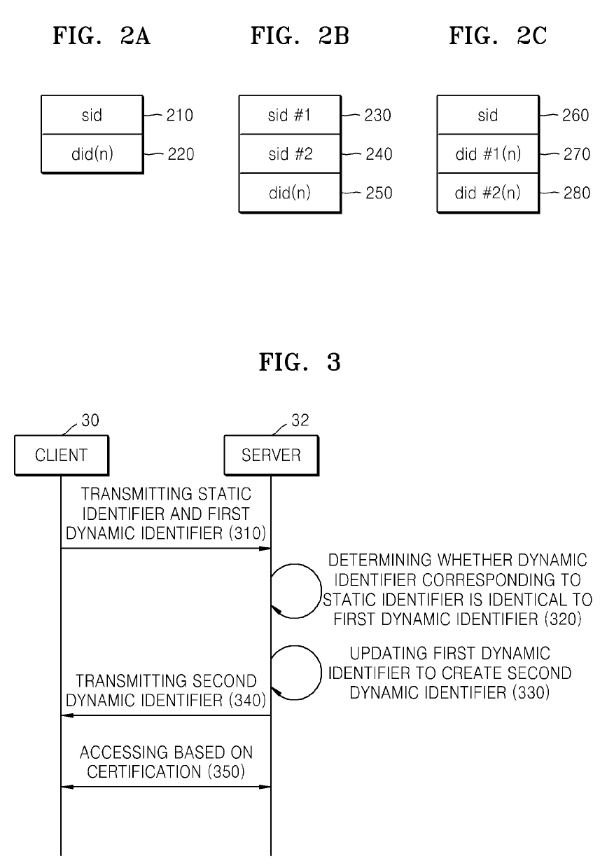

The static identifier may be a combination of at least two or more individual values which is used to distinguish the client 10 from other devices such as a serial number assigned to the client 10 during the manufacture of the client 10 and/or a serial number of software installed in the client 10. In addition, the first dynamic identifier may be a random number corresponding to the static identifier. The static identifier and the dynamic identifier corresponding to the static identifier will be described in more detail with reference to FIGS. 2A to 2C.

In operation 120, the second server 14 compares the static identifier and the first dynamic identifier received from the client 10 in operation 110 with a static identifier and a dynamic identifier corresponding to the static identifier stored in the second server 14.

If the static identifiers are identical to each other, but the first dynamic identifier received in operation 110 is not identical to the first dynamic identifier of the second server 14, the second serve 14 determines that the client 10 is not genuine and denies the client 10 access to the second server 14. On the other hand, if the static identifier and the first dynamic identifier received in operation 110 are identical to the static identifier and the first dynamic identifier of the second server 14, the second server 14 confirms the validity of the client 10 and proceeds to operations 130 to 150.

In operation 130, the second server 14 updates the first dynamic identifier received from the client 10 to create a second dynamic identifier. Since only the dynamic identifier is updated without updating the static identifier, an unauthorized copy of the device unaware of the updated dynamic identifier cannot be certified. The dynamic identifier may be updated whenever the client 10 communicates with the first server 12 or may be periodically updated. For example, the dynamic identifier may be updated once a week or once a month. Alternatively, the dynamic identifier may be updated once every predetermined numbers of accesses by the client 10. The second dynamic identifier may also be a random number like the first dynamic identifier.

In operation 140, the second server 14 transmits the second dynamic identifier to the client 10. The second server 14 transmits the second dynamic identifier created by updating the first dynamic identifier to the client 10, and the client 10 stores the received second dynamic identifier as a new dynamic identifier corresponding to the static identifier. The stored second dynamic identifier is used in the next communication between the client 10 and the first server 12.

In operation 150, the client 10 accesses the first server 12 based on the second dynamic identifier received from the second server 14 in operation 140. Further, the second server 14 transmits the static identifier and the second dynamic identifier of the client 10 directly to the first server 12, and the first server 12 allows access to the client 10 only when the client 10 attempts access based on the second dynamic identifier. Since the unauthorized copy of the device is not aware of the updated second dynamic identifier obtained by updating the first dynamic identifier, access of the unauthorized copy of the device to the first server 12 is denied.

The second server 14 may inform the first server 12 of information of the identifiers of the client 10 by sharing a database of the second server 14 including information about the static identifier and the second dynamic identifier of the client 10 with the first server 12 instead of directly transmitting the static identifier and the second dynamic identifier of the client to the first server 12. If the first server 12 and the second server 14 are a plurality of servers contained in a single physical server and logically separated according to functions thereof, the first server 12 and the second server 14 may share information on the static identifier and the second dynamic identifier of the client 10 without any further communication.

FIGS. 2A to 2C illustrate a plurality of identifiers according to an embodiment of the present invention. The identifiers illustrated in FIGS. 2A to 2C are used for certification including operations 110 to 140.

Referring to FIG. 2A, a pair of a static identifier 210 and a dynamic identifier 220 are used in the process of certification including operations 110 to 140. The static identifier 210 is a unique identifier of the client 10 and is not changed unlike the dynamic identifier 220 which is updated on every communication or periodically.

In a first communication between the client 10 and the first server 12, the dynamic identifier 220 may be set to be the same as the static identifier 210. Alternatively, the dynamic identifier 220 may be set to be a random value different from the static identifier 210. For example, the dynamic identifier 220 may be a serial number only containing “0” or “1” and changed during the first communication.

Referring to FIG. 2B, a plurality of static identifiers 230 and 240 may be used. If the client 10 consists of a plurality of elements, and the combination of the elements verifies the authenticity of the client 10, certification may be performed using a plurality of static identifiers 230 and 240 and a dynamic identifier 250. For example, both a serial number of hardware A and a serial number of software which can be installed only in the hardware A may be used as the static identifiers 230 and 240. Since the serial number of the software is used as the static identifier, an unauthorized copy of the software installed in the client 10 may also be detected by verifying the authenticity of both of the client 10 and software.

A CPU serial number and a hard disk serial number which are hardware serial numbers may be used as the plurality of static identifiers 230 and 240. An element of hardware cannot be changed by using a plurality of hardware serial numbers, thereby inhibiting unauthorized modification of hardware.

Even though FIG. 2B illustrates two static identifiers, more than two static identifiers may be used.

Referring to FIG. 2C, a plurality of dynamic identifiers 270 and 280 may be used. Certification may be more accurately performed using the plurality of dynamic identifiers 270 and 280. For example, a dynamic identifier did#1(n) 270 is set to be a dynamic identifier used during the previous communication between the client 10 and the first server 12, and a dynamic identifier did#2(n) 280 is set to be a new dynamic identifier created by the second server 14 by updating the did#1(n) 270. Thus, the first server 12 allows the client 10 access only when the dynamic identifiers 270 and 280 are valid, thereby increasing accuracy of the certification.

The client may also be allowed access when only one of the dynamic identifiers 270 and 280 is valid by using the plurality of dynamic identifiers 270 and 280. Here, authenticity of a plurality of clients may be verified. For example, authenticity of two clients having the same static identifier 260 may be verified using different dynamic identifiers 270 or 280, and the clients may access the first server 12.

Even though FIG. 2C illustrates two dynamic identifiers, more than two dynamic identifiers may be used.

In addition, certification may be performed using a plurality of static identifiers and a plurality of dynamic identifiers by combining FIGS. 2B and 2C.

FIG. 3 is a flowchart illustrating a communication method according to another exemplary embodiment of the present invention.

FIG. 3 illustrates a method of certification using identifiers according to an exemplary embodiment of the present invention when a server providing contents and a server performing the certification are not physically or logically separated.

Referring to FIG. 3, in operation 310, a client 30 transmits a static identifier and a first dynamic identifier to a server 32.

In operation 320, the server 32 compares the static identifier and the first dynamic identifier received from the client 30 in operation 310 with a static identifier and a dynamic identifier corresponding to the static identifier stored in the server 32.

If the static identifiers are identical to each other, but the first dynamic identifier received in operation 310 is not identical to the dynamic identifier of the server 32, the server 32 determines that the client 30 is not genuine and denies the client 30 access to the server 32. On the other hand, if the static identifier and the first dynamic identifier received in operation 310 are identical to the static identifier and the dynamic identifier of the server 32, the server 32 confirms the validity of the client 30 and proceeds to operations 330 to 350.

In operation 330, the server 32 updates the first dynamic identifier received from the client 30 to create a second dynamic identifier. As described above, the first dynamic identifier may be updated whenever the client 30 communicates with the server 32 or may be periodically updated.

In operation 340, the second server 120 transmits the second dynamic identifier to the client 30.

In operation 350, the client 30 accesses the server 32 based on the result of the certification of operations 310 to 340, and the server 32 only allows access of the client 30 that is valid. That is, a device only based on the updated dynamic identifier is allowed access.

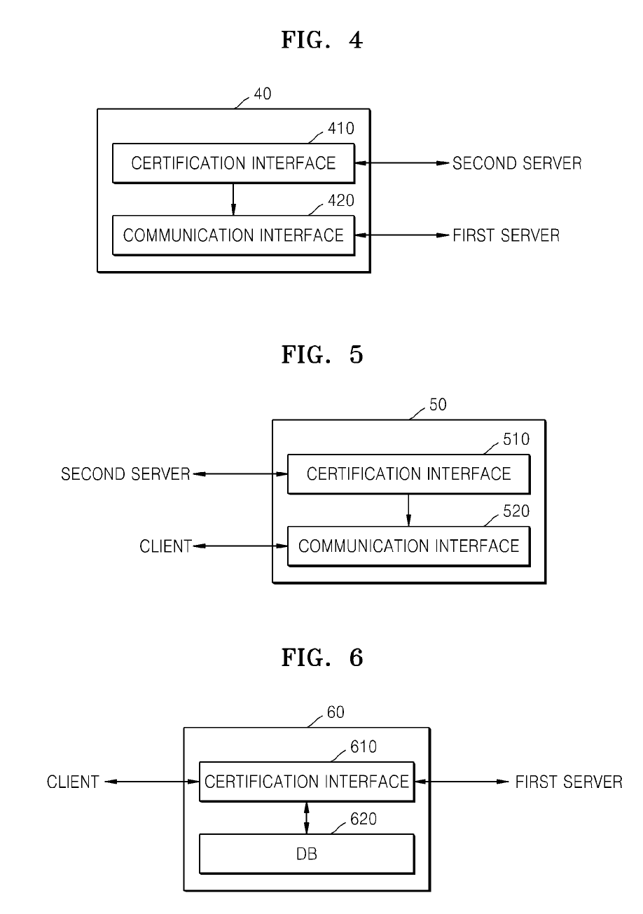

FIG. 4 illustrates a client according to an embodiment of the present invention.

Referring to FIG. 4, a client 40 includes a certification interface 410 and a communication interface 420.

The certification interface 410 transmits a static identifier and a first dynamic identifier to a second server which is a certification server. The second server is a certification server updating a dynamic identifier of the client 40. The first dynamic identifier is a dynamic identifier received from the second server and previously used in a communication between the client 40 and the first server which is a content server. When the client 40 initially accesses the first server, the static identifier may be identical to the first dynamic identifier. The static identifier and the first dynamic identifier are described in detail with reference to FIGS. 2A to 2C.

In addition, the certification interface 410 receives from the second server the second dynamic identifier which is created by the second server by updating the first dynamic identifier. The second dynamic identifier is a new dynamic identifier required for the client to access the first server. The second server updates the first dynamic identifier received from the certification interface 410 to create the second dynamic identifier. The second dynamic identifier may be created whenever the client 40 accesses the first server or may be periodically created.

The communication interface 420 accesses the first server based on the second dynamic identifier received from the certification interface 410. Since the first server is aware of the second dynamic identifier since it received the second dynamic identifier from the second server, the client 40 is allowed access only based on the second dynamic identifier, and an unauthorized copy of the device based on a dynamic identifier different from the second dynamic identifier may be denied access.

FIG. 5 illustrates a first server according to an exemplary embodiment of the present invention.

Referring to FIG. 5, a first server 50 includes a certification interface 510 and a communication interface 520. The first server 50 is a content server providing contents to a client which was certified by a second server.

The certification interface 510 receives a static identifier and a second dynamic identifier of the client from a second server which is a certification server. The second dynamic identifier is created whenever the client accesses the first server 50 or is periodically created by updating the first dynamic identifier which was used in the previous access.

The communication interface 520 receives the static identifier and the second dynamic identifier of the client 10 from the certification interface 510 and allows the client 10 access based thereon. If the access of the client is based on the second dynamic identifier, the access is allowed. If the access of the client is based on a dynamic identifier different from the second dynamic identifier, the access is denied.

FIG. 6 illustrates a second server according to an embodiment of the present invention.

Referring to FIG. 6, a second server 60 includes a certification interface 610 and a database 620. The second server 60 is a certification server performing certification of a client and transmits a second dynamic identifier updated according to the results of the certification to a first server.

The certification interface 610 receives a static identifier and a first dynamic identifier of the client and updates the first dynamic identifier to create a second dynamic identifier. Then, the certification interface 610 stores the static identifier and the created second dynamic identifier corresponding to the static identifier in the database 620 and transmits them to the first server. The second server may inform the first server of data of the static identifier and the second dynamic identifier of the client by sharing information on the identifiers stored in the database 620 instead of directly transmitting the static identifier and the second dynamic identifier of the client to the first server.

While the present invention has been particularly shown and described with reference to exemplary embodiments thereof, it will be understood by those of ordinary skill in the art that various changes in form and details may be made therein without departing from the spirit and scope of the present invention as defined by the following claims. The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. In other exemplary embodiments, the computer readable medium may include carrier waves (such as data transmission through the Internet). The computer readable recording medium can also be distributed over network coupled computer systems so that the computer readable code is stored and executed in a distributed fashion.

What is claimed is:

1. A method of communication of a client with a first server, the method comprising:
transmitting a static identifier and a first dynamic identifier to a second server;
receiving from the second server a second dynamic identifier created by the second server by updating the first dynamic identifier; and
accessing the first server based on the second dynamic identifier,
wherein the first dynamic identifier is a dynamic identifier previously received from the second server in a previous process to communicate with the first server.

2. The method of claim 1, wherein the second server updates a dynamic identifier whenever the client communicates with the first server.

3. The method of claim 2, wherein the first dynamic identifier and the second dynamic identifier are random numbers.

4. The method of claim 1, wherein the first dynamic identifier is identical to the static identifier when the client is in a process to initially access the first server.

5. A method of communication of a first server with a client, the method comprising:
receiving from a second server a static identifier and a second dynamic identifier created by updating a first dynamic identifier, of the client; and
allowing an access of the client based on the second dynamic identifier,
wherein the second server receives from the client the static identifier and the first dynamic identifier, determines whether a previous dynamic identifier corresponding to the static identifier is identical to the first dynamic identifier in a determination, updates the first dynamic identifier based on a result of the determination to create a second dynamic identifier, and transmits the second dynamic identifier to the client.

6. The method of claim 5, wherein the second server updates a dynamic identifier whenever the client communicates with the first server.

7. The method of claim 6, wherein the first dynamic identifier and the second dynamic identifier are random numbers.

8. The method of claim 5, wherein the first dynamic identifier is identical to the static identifier when the client is in a process to initially access the first server.

9. A client apparatus communicating with a first server comprising:
a certification interface which transmits a static identifier and a first dynamic identifier to a second server, and receives from the second server a second dynamic identifier created by the second server by updating the first dynamic identifier; and
a communication interface which accesses the first server based on the second dynamic identifier,
wherein the first dynamic identifier is a dynamic identifier previously received from the second server in a previous process to communicate with the first server.

10. The client apparatus of claim 9, wherein the second server updates a dynamic identifier whenever the client communicates with the first server.

11. The client apparatus of claim 10, wherein the first dynamic identifier and the second dynamic identifier are random numbers.

12. The client apparatus of claim 9, wherein the first dynamic identifier is identical to the static identifier when the client is in a process to initially access the first server.

13. A first server apparatus communicating with a client comprising:
a certification interface which receives from a second server a static identifier and a second dynamic identifier created by the second server by updating a first dynamic identifier; and
a communication interface which allows an access of the client based on the second dynamic identifier,
wherein the second server receives from the client the static identifier and the first dynamic identifier, determines whether a previous dynamic identifier corresponding to the static identifier is identical to the first dynamic identifier in a determination, updates the first dynamic identifier based on a result of the determination to create a second dynamic identifier, and transmits the second dynamic identifier to the client.

14. The first server apparatus of claim 13, wherein the second server updates a dynamic identifier whenever the client communicates with the first server.

15. The first server apparatus of claim 14, wherein the first dynamic identifier and the second dynamic identifier are random numbers.

16. The first server apparatus of claim 13, wherein the first dynamic identifier is identical to the static identifier when the client is in a process to initially communicate with the first server.

17. A computer-readable recording medium having recorded thereon a program for operating the method of claim 1.

18. A computer-readable recording medium having recorded thereon a program for operating the method of claim 5.

19. The method of claim 1, wherein the first server provides a content to the client in the accessing, the client is a terminal, the terminal being one of including a display unit or being connected to a display unit, and the second server is a certification server.

20. The method of claim 19, wherein the static identifier comprises at least two individual values, one of the at least two individual values comprising one of a serial number of the client and a serial number of a software installed in the client.
